(19) United States
(12) Patent Application Publication
(10) Pub. No.: US 2022/0138842 A1
(43) Pub. Date: May 5, 2022

(54) CUSTODIAL ACCOUNT MANAGEMENT TOOL

(71) Applicant: Wells Fargo Bank, N.A., San Francisco, CA (US)

(72) Inventors: Abraham Drucker, San Francisco, CA (US); Khushbu Katariya, San Francisco, CA (US); Timothy R. Knowlton, Mill Valley, CA (US); Shelby Morita-Fowler, San Francisco, CA (US); Brian M. Pearce, Pleasanton, CA (US); Dana Roytenberg, San Francisco, CA (US); John T. Wright, Benicia, CA (US)

(21) Appl. No.: 16/216,851

(22) Filed: Dec. 11, 2018

(51) Int. Cl. G06Q 40/02; H04L 29/06; G06Q 20/40; G06Q 20/42

(52) U.S. Cl. CPC G06Q 40/02; G06Q 20/42; G06Q 20/405; H04L 63/102

(57) ABSTRACT

A method includes collecting account data for an account from an authentication server. The method also includes receiving a request for the account data from an owner of the account or from a custodial entity. The method further includes determining a portion of the account data that may be accessed based on a permissions grid. The permissions grid includes a list of authorized entities including at least one of the owner or the custodial entity. The permissions grid also includes a list of permissions associated with each entity from the list of authorized entities. The method includes transmitting the portion of the account data in response to the request.

### BACKGROUND

The present disclosure relates generally to the field of managing an account. More specifically, the present disclosure relates to methods and apparatuses that facilitate management of an account. Many lenders and holding companies provide services that allow an owner of an account to remotely access account data. The service may be in the form of a software tool that enables remote access to the account. The service may allow the owner to monitor account activity and add or remove holdings from the account. Traditionally, these services limit access to the account to a single individual (e.g., the owner of the account). When the account owner dies or becomes mentally incapacitated, access to the account by designated individuals, such as a power of attorney (POA), can be very difficult. In some cases, account access privileges cannot be obtained without direct intervention by the lender or holding company that manages the account.

In some situations, limiting account access to a single individual may also jeopardize account security. For example, an account owner that is suffering from dementia or another cognitive disease or disorder may be more susceptible to fraudulent activities or that may result in the loss of holdings from an account. In another example, the account owner may be unable to adequately monitor account activity on their own to identify fraudulent transactions. Existing account management services do not provide sufficient safeguards against these types of activities.

### SUMMARY OF THE INVENTION

One embodiment of the present disclosure relates to a method. The method includes collecting, by a network server, account data for an account from an authentication server. The method includes receiving a request for the account data. The method further includes determining a portion of the account data that may be accessed based on a permissions grid. The method further includes transmitting the portion of the account data to a computing device. The permissions grid includes a list of authorized entities including at least one of an owner of the account or a custodial entity. The permissions grid also includes a list of permissions associated with each entity from the list of authorized entities. In some embodiments, the method further includes crawling through the permissions grid to identify permissions associated with the owner or the custodial entity and selectively restricting the account data based on the permissions.

In some embodiments, the method additionally includes receiving a transaction request to withdrawal an amount of holdings from an account. The transaction request is initiated by one of the owner and the custodial entity. The method may include crawling through the list of permissions associated with the owner or the custodial entity to identify a threshold value associated with the transaction request. The method includes comparing the amount with the threshold value. The method includes submitting the request to the authentication server based on a determination that the amount is below the threshold value.

In some embodiments, the method additionally includes receiving a transaction request, initiated by the custodial entity, to withdrawal an amount of holdings from an account. The method may include crawling through the list of permissions associated with the custodial entity to identify a threshold value associated with the transaction request. The method includes comparing the amount with the threshold value. The method includes transmitting a notification of the transaction request to the computing device based on a determination that the amount exceeds the threshold value. In some embodiments, the notification prompts the owner or another entity from the list of authorized entities to view and approve or deny the transaction request.

In some embodiments, the transaction request may be initiated by the owner and the notification prompts the custodial entity to view and approve or deny the transaction request.

In some embodiments the transaction request includes a note including comments associated with the transaction request. The method may include storing the note as part of a non-modifiable list of transaction operations.

In some embodiments, the method additionally includes receiving a request from the computing device to modify permissions for the custodial entity. The permissions may include an access permission and a threshold value. The threshold value may be an amount of a transaction or a number of transactions. The method may include updating the permissions in the permissions grid.

Another embodiment of the present disclosure relates to a method. The method includes transmitting, by a computing device, a request for account data for an account. The request is initiated by an owner of the account or by a custodial entity. The method includes receiving a portion of the account data. The portion of the account data is determined based on a permissions grid. The permissions grid includes a list of authorized entities including at least one of the owner and the custodial entity. The permissions grid also includes a list of permissions associated with each entity from the list of authorized entities. The method further includes displaying the portion of the account data on a user interface of the computing device.

In some embodiments, the method additionally includes displaying a dashboard configured to provide access to at least one of the owner or the custodial entity to the portion of the account data. The method may include displaying a modifiable permissions grid that summarizes the list of permissions associated with an entity from the list of authorized entities. The method may include modifying an access permission and a threshold value associated with the access permission from the modifiable permissions grid. The threshold value is an amount of a transaction or a number of transactions. The method may include transmitting a request to modify the permissions to a network server.

Another embodiment of the present disclosure relates to a system. The system includes a network server. The network server includes a transceiver, memory, and a processor operatively coupled to the transceiver and memory. The transceiver is configured to transmit and receive data from an authentication server, which contains account data for an account. The memory is configured to store the account data retrieved from the authentication server. The memory is also configured to store a permissions grid that includes a list of authorized entities including at least one of an owner of the account or a custodial entity. The permissions grid also includes a list of permissions associated with each entity from the list of authorized entities. The processor is configured to determine a portion of the account data that may be accessed based on the permissions grid.

In some embodiments, the system may include a computing device including memory configured to store an application. The application may include a dashboard configured to provide access by at least one of the owner or the custodial entity to the portion of the account. The dashboard may be configured to provide access to a modifiable permissions grid that summarizes the list of permissions associated with an entity from the list of authorized entities.

In some embodiments, the computing device is configured to collect, and transmit to the network server, a signature entered into the application from the user interface by the owner or the custodial entity.

In some embodiments, the application includes a setup wizard. The setup wizard may be configured to prompt the owner, an authorized custodial entity, or an administrator, to specify the list of authorized entities and the list of permissions. The setup wizard may be configured to prompt the owner, the authorized entity, or the administrator, to enter implementation criteria that determines a point at which access to the dashboard is provided to the custodial entity.

Another embodiment of the present disclosure relates to a non-transitory computer-readable medium having computer-readable instructions stored thereon that, upon execution by a processor, cause a computing device to perform operations. The instructions include instructions to collect account data for an account from an authentication server. The instructions also include instructions to determine a portion of the account that may be accessed based on a permissions grid. The permissions grid includes a list of authorized entities. The list of authorized entities includes at least one of an owner of the account and a custodial entity. The permissions grid also includes a list of permissions associated with each entity from the list of authorized entities. The instructions further include instructions to transmit the portion of the account data to a computing device.

In some embodiments, the instructions to determine a portion of the account data that may be accessed include instructions to crawl through the permissions grid to identify permissions associated with the owner or the custodial entity and instructions to selectively restrict the account data based on the permissions. In some embodiments, the instructions further include instructions to generate and transmit a modifiable permissions grid that summarizes the list of permissions associated with an entity from the list of authorized entities. The modifiable permissions grid may provide functionality that allows at least one of the owner and the custodial entity to modify permissions associated with the entity including an access permission and a threshold value.

### BRIEF DESCRIPTION OF THE DRAWINGS

FIG. 1 is a block diagram of a custodial account management system, according to an illustrative embodiment.

FIG. 2 is a block diagram of an authentication server for the custodial account management system of FIG. 1, according to an illustrative embodiment.

FIG. 3 is a block diagram of a network server for the custodial account management system of FIG. 1, according to an illustrative embodiment.

FIG. 4 is a block diagram of a computing device for the custodial account management system of FIG. 1, according to an illustrative embodiment.

FIG. 5 is a flow schematic of a method of accessing account data using a custodial account management system, according to an illustrative embodiment.

FIG. 6 is a flow schematic of a method of restricting account data for a custodial account management system, according to an illustrative embodiment.

FIG. 7 is a diagram of a permissions grid for a custodial account management system, according to an illustrative embodiment.

FIG. 8 is a flow schematic of a method of restricting viewable account data for a custodial account management system, according to an illustrative embodiment.

FIG. 9 is block diagram of a dashboard for a custodial account management system, according to an illustrative embodiment.

FIG. 10 is a flow schematic of a method of modifying permissions for a custodial account management system, according to an illustrative embodiment.

FIG. 11 is a flow schematic of a method of accessing and transmitting a modifiable permissions grid to a computing device, according to an illustrative embodiment.

FIG. 12 is a flow schematic of a method of preparing and processing a transaction request for a custodial account management system, according to an illustrative embodiment.

FIG. 13 is an illustration of a transaction request window for a custodial account management system, according to an illustrative embodiment.

FIG. 14 is an illustration of a notification window for a custodial account management system, according to an illustrative embodiment.

FIG. 15 is a flow schematic of a method of initializing a custodial account management system, according to an illustrative embodiment.

### DETAILED DESCRIPTION

Described herein are methods and systems for account monitoring and management by multiple individuals including an owner of an account and a custodial entity. The custodial entity may be an entity who is authorized by the owner of the account to perform certain account management functions. The disclosed methods and systems provide functionality by which both the owner and the custodial entity may be selectively authorized or prevented from performing a variety of account functions based on numerous thresholds. The disclosed methods and systems also provide functionality by which both the owner and the custodial entity may request and set authorizations to act with respect to the account (e.g., functionality by which the owner and the custodial entity may request a change to one or more account permissions/thresholds, etc.). Among other benefits, providing multiple designated entities with access to an account may help reduce the burden on elderly individuals, or individuals who are no longer capable of effectively managing their accounts on their own. The ability to designate different access permissions and change permissions also provides a safeguard against fraudulent activities that may be undertaken by a single entity.

An illustrative embodiment of a custodial account management system includes a network server, a computing device, and an authentication server. The network server is configured to collect account data for an account from the authentication server. The network server, in response to a request for the account data by an owner of the account or a custodial entity, is configured to determine a portion of the account data that may be accessed. The portion of the account data is determined based a permissions grid. The permissions grid includes a list of authorized entities including the custodial entity. In some embodiments, the list of authorized entities also includes the owner. The permissions grid further includes a list of permissions associated with each entity from the list of authorized entities. The network server may be configured to crawl through (e.g., step through, examine, etc.) the permissions grid to identify permissions associated with the custodial entity and selectively restrict the account data based on the permissions. The network server is configured to transmit the portion of the account data to the computing device. The computing device may include a user interface from which the owner or the custodial entity may view the portion of the account data and perform various account management functions.

According to an illustrative embodiment, the computing device is configured to display a custodial dashboard that includes a viewable portion of the account data. The custodial dashboard also provides functionality by which the owner may view and modify permissions associated with the account. In some embodiments, the custodial dashboard also provides functionality by which the custodial entity may view and modify permissions associated with the account.

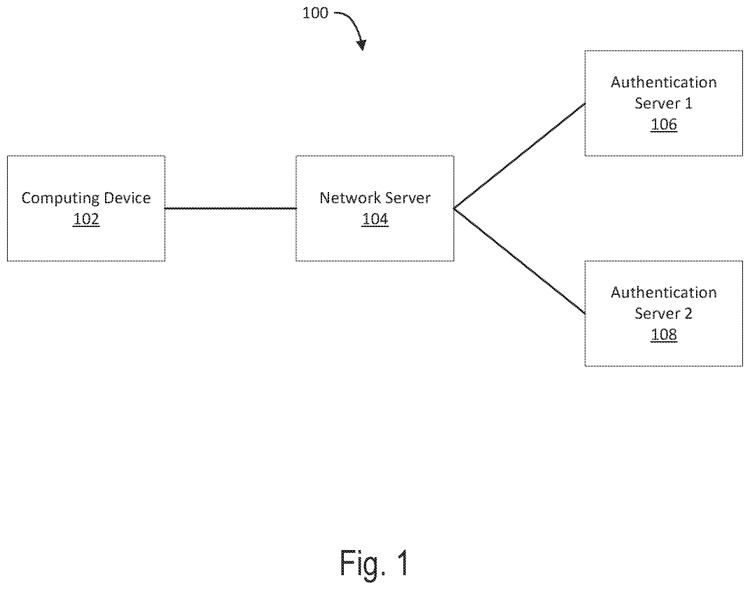

FIG. 1 is a block diagram of a custodial account management system 100, according to an illustrative embodiment. In alternative embodiments, the system may include additional, fewer, and/or different components. The custodial account management system 100 includes a computing device 102, a network server 104, and a plurality of authentication servers including a first authentication server 106 and a second authentication server 108. In alternative embodiments, additional or fewer authentication servers 106, 108 may be included. As shown in FIG. 1, the computing device 102 and the first and second authentication servers 106, 108 are coupled to the network server 104.

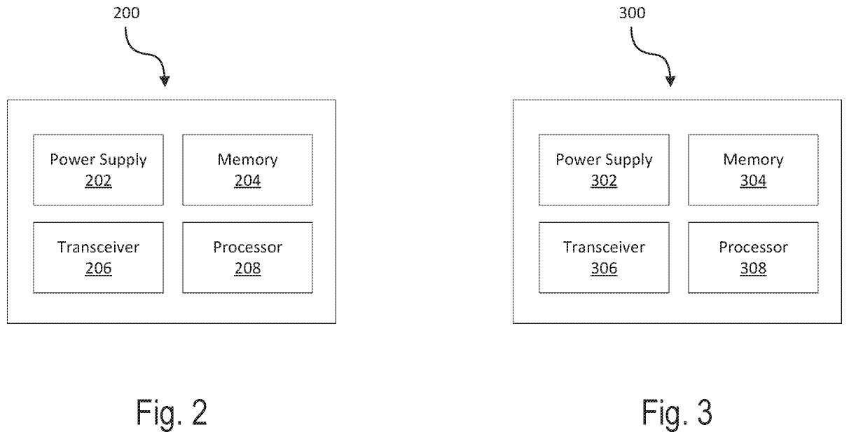

According to an illustrative embodiment, each of the authentication servers 106, 108 is configured to provide access to a single secure account. Alternatively, each authentication server 106, 108 may provide access to more than one account. The authentication servers 106, 108 are configured to validate and authenticate remote connections to ensure that only authorized devices are able to access the servers, applications, storage, or other resources behind the authentication servers 106, 108. In some implementations, the authentication servers 106, 108 may be network servers for a banking or other financial institution. Each authentication server 106, 108 may be configured to provide access to account data including account balances, transaction histories, and security credentials associated with the account. The account may be a transactional account from which an individual can safely store money or other holdings, or a mortgage account or other lien account to which an individual can submit payments. Alternatively, the account may be an investment account through which the individual may purchase and trade stocks, mutual funds, and/or other business holdings. In some embodiments, the account may be a business account owned and managed by authorized individuals within the company. The authentication server 106, 108 may provide access to a variety of account management functions. For example, the authentication server 106, 108 may provide a user (e.g., an owner of the account, an authorized custodial entity, etc.) with the ability to move holdings (e.g., money, etc.) between different accounts, to withdrawal money from the account, and/or to deposit money into the account. An illustrative embodiment of an authentication server 200 is described in more detail with reference to FIG. 2.

As referred to herein, an “owner” of the account is an individual person or group of people with direct ownership, or who have a stake in ownership, over the holdings in the account. A “custodial entity” is an individual who is authorized by the owner to access at least a portion of the account. For example, a transactional account may be owned by a single person who invests their earnings into the account. The individual may designate one or more entities access privileges that enable the entities to view transactions and account balances, or move holdings into and out of the account. In this example, the owner of the account is the individual whose earnings are invested in the account, while each designee is a custodial entity.

The network server 104 is configured to collect information from each authentication server 106, 108. The network server 104 may be configured to collect account data such as account balances, transaction history, etc. from each authentication server 106, 108. The network server 104 may be configured to transmit user credentials to each authentication server 106, 108 so as to identify itself to each authentication server 106, 108. In alternative embodiments, the network server 104 may also function as an authentication server 106, 108 (e.g., the network server 104 may store account data, provide access to a variety of account management functions, etc.).

As shown in FIG. 1, the network server 104 is configured to transmit and receive data (commands, instructions, values, etc.) from the computing device 102. According to an illustrative embodiment, the network server 104 is configured to receive a request for account data from the computing device 102. The network server 104 is configured to determine a portion of the account data that may be accessed by a user of the computing device 102 (e.g., an owner of the account or a custodial entity). The portion of the account data may be determined by the network server 104 based on a permissions grid. The network server 104 may be configured to crawl through the permissions grid to identify permissions associated with the user. The network server 104 may be configured to selectively restrict an amount of account data based on the permissions. The network server 104 may be configured to transmit the portion of the account data to the computing device 102. An illustrative embodiment of a network server 300 is described in more detail with reference to FIG. 3.

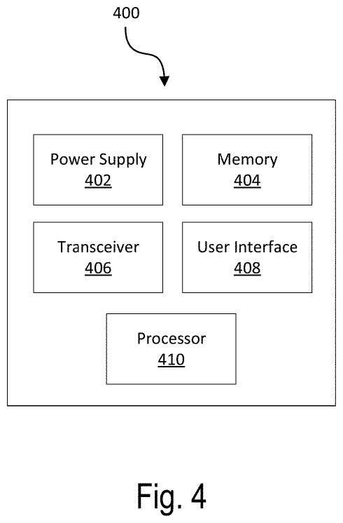

The computing device 102 is configured to transmit and receive data (e.g., commands, instructions, values, etc.) from the network server 104. The computing device may be any network connected device including a laptop, a mobile phone, a tablet, or another internet connected device. The computing device 102 may be configured to transmit a request for account data to the network server 104 on behalf of an owner of the account or a custodial entity. The computing device 102 may be configured to receive a portion of the account data based on credentials provided by the computing device 102 to the network server 104 (e.g., user credentials associated with the owner or the custodial entity). The computing device 102 may be configured to display the portion of the account data to the owner or the custodial entity. In some implementations, the computing device 102 may be configured to transmit transaction requests to the network server 104 including withdrawal requests in which money or other holdings are to be debited from the account and deposit requests in which money or other holdings are to be credited to the account. The computing device 102 may also be configured to transmit requests to modify one or more permissions associated with access to the account. An illustrative embodiment of a computing device 400 is described in more detail with reference to FIG. 4.

As shown in FIG. 1, the network server 104 is communicatively coupled to the computing device 102 and each of the authentication servers 106, 108. In some implementations, the custodial account management system 100 may further include a network (not shown) to facilitate communication between the computing device 102 and the network server 104, or between the network server 104 and the authentication servers 106, 108. The network may include a short a short-range communication network such as a Bluetooth network, a Zigbee network, etc. The network may also include a local area network (LAN), a wide area network (WAN), a telecommunications network, the Internet, a public switched telephone network (PSTN), and/or any other type of communication network known to those of skill in the art.

FIG. 2 is a block diagram of an authentication server 200, according to an illustrative embodiment. In alternative embodiments, the authentication server 200 may include additional, fewer, and/or different components. As shown in FIG. 2, the authentication server 200 includes a power supply 202, memory 204, a transceiver 206, and a processor 208. According to an illustrative embodiment, the power supply is a battery. Alternatively, the authentication server 200 may be hard-wired to a building (e.g., a utility grid, a generator, a solar cell, a fuel cell, etc.). In an embodiment where the authentication server 200 is hard-wired, the power supply 202 may additionally include a battery for backup during power outages and to prevent accidental loss of data. Memory 204 for the authentication server 200 may be configured to store account data. The account data may include account balances, transaction histories, credentials associated with the owner or the custodial entity, notes or memos associated with a transaction, etc. Memory 204 may also be configured to store transaction instructions. The transaction instructions may include withdrawal instructions in which money or other holdings are to be debited from an account and/or deposit instructions in which money or other holdings are to be credited to the account.

The transceiver 206 may include a transmitter for transmitting information and/or a receiver for receiving information. According to an illustrative embodiment, the transceiver 206 is configured to receive requests and instructions from the network server 104 (see also FIG. 1). The request may be a request for account data or a transaction request to withdrawal or deposit holdings into an account. The transceiver 206 may be configured to transmit account data in response to the request.

The processor 208 may be operatively coupled to each of the components of the authentication server 200, and may be configured to control interaction between the components. For example, the processor 208 may be configured to interpret requests and/or instructions received by the transceiver 206, to retrieve (e.g., access and sort through) account data stored in memory 204, and to route the account data to the transceiver 206 for transmission to the network server 104. The processor 208 may also be configured to verify user credentials so as to prevent unwanted access to account data and other functions related to the management and security of the account.

FIG. 3 is a block diagram of a network server 300, according to an illustrative embodiment. In alternative embodiments, the network server 300 may include additional, fewer, and/or different components. As shown in FIG. 3, the network server 300 includes a power supply 302, memory 304, a transceiver 306, and a processor 308. According to an illustrative embodiment, the power supply 302 is the same or similar to the power supply 202 described with reference to FIG. 2. Memory 304 for the network server 300 may be configured to store account data received from the authentication servers 106, 108 (see also FIG. 1). Memory 304 may also be configured to store a permissions grid for the custodial management system 100. The permissions grid may include access privileges associated with a custodial entity who is designated by the owner to have access to the account. The permissions grid may also include access privileges associated with an owner of the account (e.g., if the owner's access privileges need to be controlled due to a medical condition or an inability to effectively manage the account independently). In an illustrative embodiment, the permissions grid includes a list of authorized entities including the custodial entity. The permissions grid further includes a list of permissions associated with each entity from the list of authorized entities.

Memory 304 may be configured to store an application. The application may include instructions to generate a dashboard configured to provide access to the owner or the custodial entity to a portion of account data received from the authentication server 106, 108 (see also FIG. 1). Memory 304 may also be configured to store values, requests, and/or instructions received from the computing device 102. For example, memory 304 may be configured to store transaction requests received from the computing device 102.

The transceiver 306, which may be similar to the transceiver 206 described with reference to FIG. 2, may be configured to receive account data from the authentication servers 106, 108 (see also FIG. 1) and to transmit requests or instructions to the authentication servers 106, 108. The transceiver 306 may also be configured to transmit a portion of the account data to the computing device 102. The portion of the account data that is transferred depends on the access privileges of the requestor (e.g., the owner or the custodial entity). The transceiver 306 may also be configured to transmit a portion of the permissions grid to the computing device 102 so that the owner can modify one or more permissions for the custodial entity. In some embodiments, the transceiver 306 may be configured to transmit a portion of the permissions grid to the computing device 102 so that the custodial entity can modify one or more permissions for another custodial entity and/or for the owner. The transceiver 306 may also be configured to receive values and requests or instructions from the computing device 102.

The processor 308 may be operatively coupled to each of the components of the network server 300, and may be configured to control interaction between the components. For example, the processor 308 may be configured to process and interpret requests received from the computing device 102 including requests for account data that are initiated by an owner of the account or a custodial entity. In an illustrative embodiment, the processor 308 is configured to determine a portion of the account data that may be accessed by the owner of the account or the custodial entity (e.g., a requestor). The processor 308 may be configured to crawl through the permissions grid stored in memory 304 and identify whether the requestor has access to the account. The processor 308 may be configured to step through the list of authorized entities in the permission grid and compare credentials provided by the requestor with each entity. The processor 308 may be configured to identify permissions associated with the requestor and selectively restrict the account data based on the permissions. The processor 308 may be configured to transmit the unrestricted portion of the account data to the computing device 102 using the transceiver 306.

According to an illustrative embodiment, the network server 300 is a cloud computing device. The network server 300 may be part of Amazon web services (AWS), an Azure cloud-based server, or another cloud computing service or platform. The network server 300 may include an application including processing instructions for transaction requests and/or other data processing instructions. The network server 300 may be accessed using any network connected device. For example, the network server 300 may be accessed from an internet connected desktop computer, or wireless device such as a laptop, tablet, or mobile phone.

FIG. 4 is a block diagram of a computing device 400, according to an illustrative embodiment. In alternative embodiments, the computing device 400 may include additional, fewer, and/or different components. As shown in FIG. 4, the computing device 400 includes a power supply 402, memory 404, a transceiver 406, a user interface 408, and a processor 410. The power supply 402 may be the same or similar to the power supply 202 described with reference to FIG. 2. According to an exemplary embodiment, memory 404 is configured to store an application. The application may include a dashboard configured to provide access to a portion of the account. The dashboard may be configured to provide access to a modifiable permissions grid for the account that summarizes the list of permissions associated with an entity from the list of authorized entities. Memory 404 may be configured to store user credentials and account data, templates for transaction requests and notifications, and personalization parameters for the dashboard (e.g., parameters relating to the organization of items within the dashboard, etc.).

The transceiver 406 may be the same or similar to the transceiver 206 described with reference to FIG. 2. In an illustrative embodiment, the transceiver 406 is configured to transmit and receive data from the network server 104 (see also FIG. 1). The transceiver 406 may be configured to receive account data from the network server 104. The transceiver 406 may also be configured to receive notifications from the network server 104 (e.g., notifications of a transaction request, account balance notifications, and notifications related to other account activities). The transceiver 406 may also be configured to transmit requests (e.g., transaction requests, etc.) from the computing device 102 to the network server 104.

The user interface 408 may be used by the owner of the account or the custodial entity to view account data and/or to submit, view, and approve or deny transaction requests. The user interface 408 may include a display such as a liquid crystal display (LCD) or other display for conveying information. The display may be configured to display the application (e.g., the dashboard) stored in memory 404. The user interface 408 may include controls, buttons, dials, or another controls interface from which the owner or the custodial entity may interact with the application. The user interface 408 may also include one or more speakers. The speakers may be configured to alert the owner or the custodial entity upon receipt of a notification from the network server 104. In alternative embodiments, the user interface 408 may include additional, fewer, and/or different components.

The processor 410 may be operatively coupled to each of the components of the computing device 400, and may be configured to control interaction between the components. In an illustrative embodiment, the processor 410 is configured to process and interpret data received by the transceiver 406 (e.g., account data, requests, and/or instructions from the network server 104). The processor 410 may be configured to construct, from the account data, a dashboard from which the portion of the account data received from the network server 104 may be accessed. The processor 410 may be configured to access memory 404 to determine personalization parameters for the dashboard. The processor 410 may be configured to interpret inputs from the user interface 408, and to transmit inputs and/or other instructions to the network server 104 using the transceiver 406.

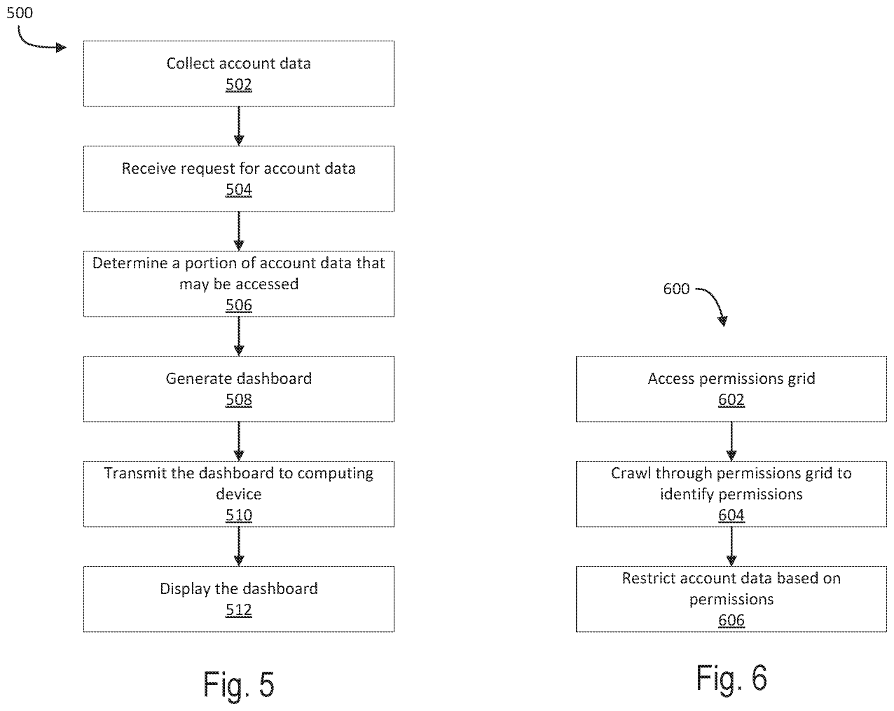

FIG. 5 is a flow diagram of a method 500 of accessing account data using the custodial account management system 100 (see also FIG. 1). In alternative embodiments, additional, fewer, and/or different operations may be performed. The use of a flow diagram and arrows for various methods described herein is not meant to be limiting with respect to the order or flow of operations. For example, in an illustrative embodiment, two or more of the operations of method 500 may be performed simultaneously.

In operation 502, the network server collects account data from an authentication server. The account data may include account data such as account balances and a transaction history. The transaction history may include a listing of withdrawals from the account and deposits into the account. The transaction history may include information that identifies an entity associated with each transaction request (e.g., an owner of the account or a custodial entity). The transaction history may also include notes, memos, or other information provided with each transaction request. The transaction history may also include information identifying each entity that approved the transaction request.

In operation 504, the network server receives a request for account data from the owner of the account or the custodial entity. The owner or the custodial entity may initiate the request from an application on the computing device. For example, the owner or the custodial entity may open the application and enter a set of user credentials identifying the owner or the custodial entity. The credentials may be submitted to the network server where they are treated as a request for account data.

In operation 506, the network server determines a portion of the account data that may be accessed by the owner or the custodial entity based on a permissions grid so as to selectively prevent unwanted access to the account. FIG. 6 is a flow schematic of a method 600 of restricting account data for a custodial account management system. In operation 602, the processor of the network server accesses the permissions grid stored in memory. In operation 604, the processor crawls through (e.g., steps through, examines, etc.) the permissions grid to identify permissions associated with an originator of the request (e.g., the owner or the custodial entity, the requestor, etc.). In operation 606, the processor restricts access to account data based on the permissions identified for the requestor in the permissions grid. The processor may iteratively remove the restricted data from the original data set (e.g., the account data received from the authentication server) or create a new data set that includes only the unrestricted data based on the permissions.

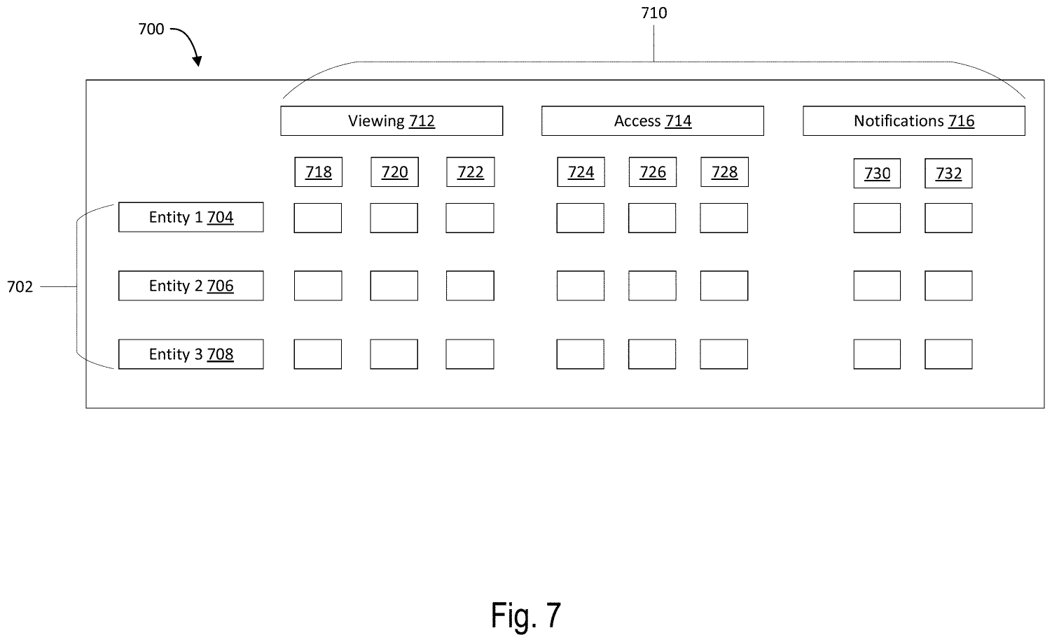

FIG. 7 is a diagram of a permissions grid 700 for a custodial account management system, according to an illustrative embodiment. The permissions grid 700 includes a list of authorized entities 702 including first entity 704, a second entity 706, and a third entity 708. In alternative embodiments, the list of authorized entities 702 may include additional or fewer entities 704, 706, 708. In an exemplary embodiment, the first entity 704 is an owner of the account. The second entity 706 and the third entity 708 are individuals to whom the owner of the account has designated access privileges (e.g., permissions) for the account. The entities are not limited to individuals; for example, one or more entities may be a business or company.

As shown in FIG. 7, the permissions grid 700 includes a list of permissions 710 associated with each entity 704, 706, 708. In alternative embodiments, the list of permissions 710 may include additional, fewer, and/or different permissions. As shown in FIG. 7, the list of permissions 710 is subdivided into sets of permissions for different account activities. The list of permissions 710 includes permissions associated with viewable account data, shown as viewing permissions 712, permissions associated with access to the account, shown as access permissions 714, and permissions associated with notifications, alerts, and approvals, shown as notification permissions 716. Each set of permissions 712, 714, 716 is further subdivided into permissions for specific functions within each activity. For example, as shown in FIG. 7, the viewing permissions 712 are subdivided into viewing permissions for account transactions 718, viewing permissions for account balances 720, and viewing permissions for notes (e.g., notes accompanying transaction requests, memo fields for bill payment requests, etc.) created by the owner or the custodial entities 722. The access permissions 714 are subdivided into access permissions to modify permissions 724, access permissions to submit transaction requests 726, and access permissions to modify the list of authorized entities 728. In alternative embodiments, the number and arrangement of permissions may be different.

The notification permissions 716 are configured to determine which entities 704, 706, 708 from the list of authorized entities 702 receive a notification, and for what reasons notifications are sent. Notifications may be utilized to facilitate monitoring and approval of a variety of different account functions. The notification permissions 716 may include permissions for single or dual custody approvals for transaction requests so as to prevent fraudulent transactions by one or more entities 704, 706, 708. The owner of the account may use the notification permissions 716 to select a designated approver (e.g., another entity 704, 706, 708 from the list of authorized entities 702, etc.). The notification permissions 716 for the designated approver may include a list of transaction operations 730. The list of transaction operations 730 may include bill payment requests, inter-account transfer requests, stock purchases or sales, requests for cash back, or other withdrawal requests. The notification permissions 716 for the designated approver may also specify a threshold value 732 beyond which approvals are required. According to an illustrative embodiment, the threshold value 732 is a monetary value so as to reduce the possibility of a single entity 704, 706, 708 performing large transactions without the knowledge and/or approval of other entities 704, 706, 708.

The notification permissions 716 may be used to specify entities 704, 706, 708 from the list of authorized entities 702 that receive notifications of an account transfer, an account transfer request, a permissions change, an account statement, or another account function. The notification may include information relating to the transaction type, the party to which money or other holdings are being transferred, and an amount of the transaction. The notification permissions 716 may be used to specify the type of notification that is sent to the computing device associated with the entity 704, 706, 708 (e.g., an audible alert, an informational pop-up, or another notification type). The notification may include a link to an application or the custodial dashboard on the computing device so that additional information about the transaction may be viewed.

The list of permissions 710 described with respect to FIG. 7 should not be considered limiting. Many additional and alternative permissions and settings may be included in the permissions grid 700 without departing from the inventive concepts described herein. For example, the permissions grid 700 may be configured to include permissions and settings relating to signature requirements for various types of transaction requests. The signature requirements may include requirements for a wet signature or an e-signature for certain account functions (e.g., account transactions, approvals, etc.). The signatures may be entered into the computing device by the owner or the custodial entity (e.g., by photocopy for a wet signature, etc.), and transmitted to the network server for storage. Among other benefits, the signature requirements provide an additional layer of security to prevent fraudulent transactions (e.g., to prevent an individual that has obtained account log-in information or other user credentials and is attempting to perform transactions, etc.). The permissions grid 700 may also be configured to allow an entity 704, 706, 708 to set renewal periods (e.g., renewal dates, etc.) after which the owner or another authorized entity 704, 706, 708 is required to view and update the permissions grid 700.

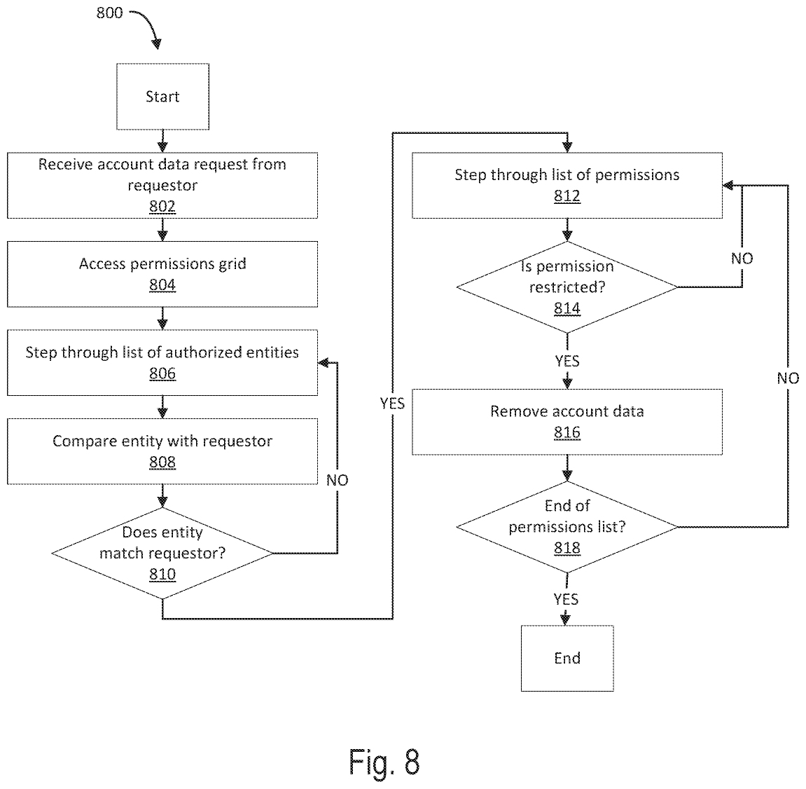

FIG. 8 is a flow schematic of a method 800 of restricting viewable account data for a custodial account management system, according to an illustrative embodiment. In alternative embodiments, additional, fewer, and/or different steps may be performed. In step 802 the network server receives a request for account data from a computing device. The request may originate from the owner or the custodial entity (e.g., a “requestor”). In step 804, the processor of the network server accesses the permissions grid stored in memory. In step 806, the processor takes a single step through the list of authorized entities from the permissions grid. In step 808, the processor compares a first entity from the list of authorized entities with information identifying the requestor. The processor repeats step 806 and step 808 until the requestor is identified (e.g., step 810). In step 812, the processor takes a single step through the list of permissions associated with the requestor. The list of permissions may be the list of viewing permissions 712 described with reference to FIG. 7. If a permission is not provided or specified (e.g., step 814), the processor removes (e.g., restricts access to) the account data corresponding to the permission (e.g., step 816). The account data may be an account balance, a transaction history, a list of permissions for an entity from the list of authorized entities, etc. The processor repeats step 812 until all of the relevant permissions for the requestor have been identified (e.g., step 818).

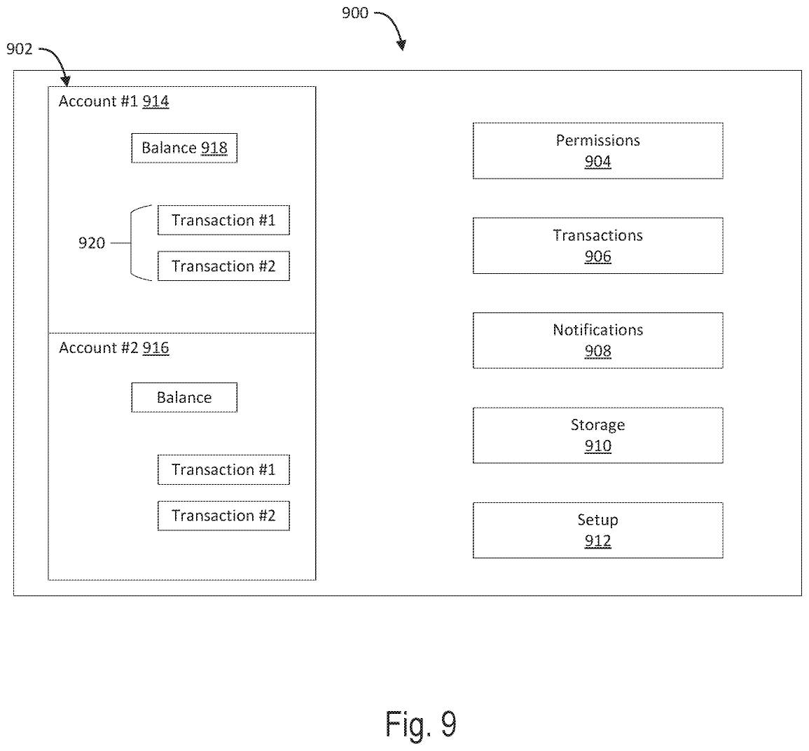

A similar approach to method 800 may be utilized by the network server to determine other restrictions (e.g., access restrictions, notifications, etc.) from the permissions grid. Returning now to FIG. 5, the method 500 of accessing account data may also include operations 508-512 to process and present the account data in a format that is convenient for access by the owner or the custodial entity. In operation 508, the network server generates a custodial dashboard configured to provide access to the owner or the custodial entity to the portion of the account data. In alternative embodiments, the computing device may be configured to generate the custodial dashboard from account data received from the network server. The dashboard may be a main page of a mobile or web application generated by the processor of the network server. The dashboard may be accessible from an application installed on the computing device (e.g., directly from an app, or from a web browser). An illustrative embodiment of a custodial dashboard will be described with reference to FIG. 9.

In operation 510, the dashboard and the portion of the account data are transmitted from the network server to the computing device. In embodiments where the dashboard is generated by the network server, the dashboard will be pre-populated with the portion of account data that may be accessed by the owner or the custodial entity. In embodiments where the dashboard is generated by the computing device, the method 500 additionally includes an operation to process and interpret the account data, and an operation to incorporate the account data into the dashboard. In operation 512, the dashboard, including the portion of the account data accessible to the owner or the custodial entity, is displayed through the user interface of the computing device (e.g., LCD display, etc.).

FIG. 9 is a block diagram of a dashboard 900 for a custodial account management system, according to an illustrative embodiment. The dashboard 900 may be configured as a main page of an application (e.g., on the computing device, or a web-based application that is accessible from a web browser on the computing device, etc.), and is configured to provide to the owner or the custodial entity a convenient interface from which one or more accounts may be monitored and managed. The look and organization of the dashboard shown in FIG. 9 is illustrative only. As shown in FIG. 9, the dashboard 900 includes a summary portion 902, a permissions portion 904, a transactions portion 906, a notifications portion 908, a storage portion 910, and a setup portion 912. In alternative embodiments, the dashboard 900 may include additional, fewer, and/or different portions.

As shown in FIG. 9, the summary portion 902 includes account data from a plurality of accounts including a first account 914 and a second account 916. The number of accounts and the information provided in the summary portion 902 for each account may be different for different entities. In some embodiments, the summary portion 902 may be structured as a printable summary so that the information can be easily disseminated and reproduced. As shown in FIG. 9, the summary portion 902 for the first account 914 includes an account balance 918 and a non-modifiable list of transaction operations 920 (e.g., a non-modifiable transaction history, etc.). Each transaction in the non-modifiable list of transactions may include information identifying the entity responsible for the transaction, any approvers for the transaction, relevant approval dates, and other transaction details (e.g., payee name, transaction amount, etc.). In some embodiments, the non-modifiable list of transactions also includes copies of signatures and notes or memos associated with each transaction. These details may be presented in their entirety on the dashboard 900. Alternatively, these details may be accessed from the dashboard 900 using links. Among other benefits, providing a non-modifiable list of transactions prevents entities from concealing their activities from other entities.

The permissions portion 904 of the dashboard 900 provides the owner or the custodial entity with the ability to view and modify permissions associated with the account. In an illustrative embodiment, the permissions portion 904 includes a link to a modifiable permissions grid, which provides functionality that allows the owner or the custodial entity to change a permission, or submit a request to change the permission. In some embodiments, the modifiable permissions grid may take the form of the permissions grid 700 as described with reference to FIG. 7. The modifiable permissions grid may include selection boxes, value entry tables, and other data entry formats to allow the owner or the custodial entity to modify the permission. In other embodiments, the permissions portion 904 may present a summary of the permissions (e.g., a printable summary, etc.) with additional links for modifying permissions.

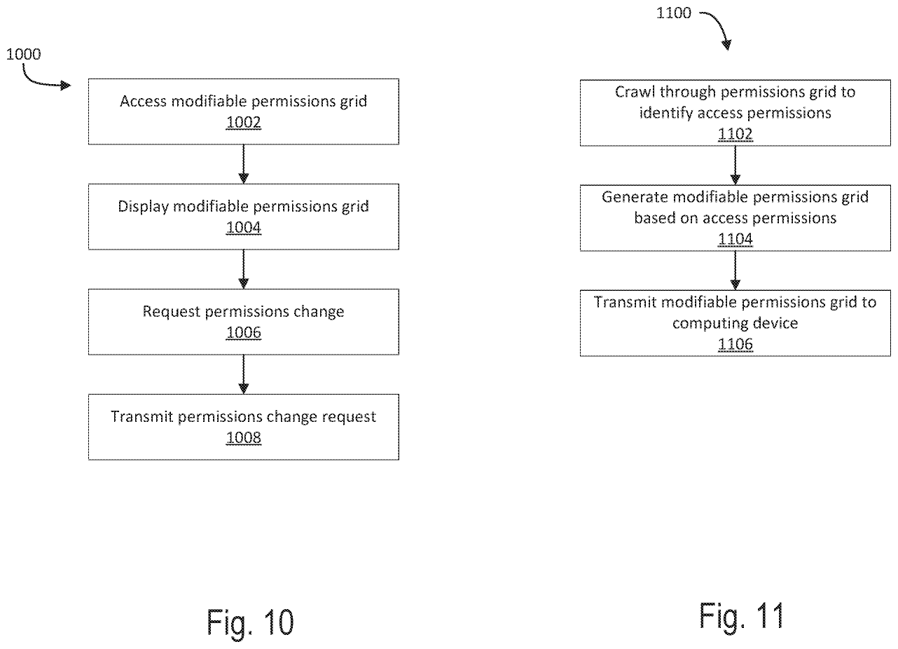

FIG. 10 is a flow schematic of a method 1000 of modifying permissions for a custodial account management system, according to an illustrative embodiment. In alternative embodiments, the method 1000 may include additional, fewer, and/or different operations. In operation 1002, the modifiable permissions grid is accessed, by an owner or custodial entity, from the permissions portion 904 of the dashboard 900 (see also FIG. 9). FIG. 11 is a flow schematic of a method 1100 of accessing and transmitting the modifiable permissions grid, or list of modifiable permissions associated with the entity, to the computing device. To access the modifiable permissions grid, the computing device transmits a request to the network server. In operation 1102, the network server crawls through (e.g., steps through, examines, etc.) the permissions grid to identify access permissions that are associated with the owner or the custodial entity. In some embodiments, the network server may also identify access permissions to modify the list of permissions (e.g., permissions for modifying a viewing permission or another set of account permissions for the requestor or another entity). Operation 1102 may be the same or similar to the method 800 described in detail with reference to FIG. 8. In operation 1104, the network server generates the modifiable permissions grid based on access permissions for the owner or the custodial entity. In operation 1106, the network server transmits the modifiable permissions grid to the computing device so that it can be viewed and modified by the owner or the custodial entity.

In operation 1004 of FIG. 10, the modifiable permissions grid is presented to the owner or the custodial entity through the user interface of the computing device. In operation 1006, a modification to the permissions is requested by the owner or the custodial entity. The permissions may include an access permission configured to selectively prevent the owner or the custodial entity from performing certain account functions or from viewing certain account data. The permissions may also include a threshold value configured to selectively limit an amount of control the owner and/or the custodial entity has with respect to the access permission. In an embodiment, the threshold value may be an amount of money or other holdings. For example, the threshold value may be a maximum amount of money that the owner or the custodial entity may remove from the account. The threshold value also may be an amount of money above which approval is required (e.g., approval or authorization from the owner or another custodial entity). In another example, the threshold value may be an amount of money above which notifications are transmitted to the computing device for further review by an owner or another custodial entity. The threshold value may further be a parameter other than an amount of money or holdings. For example, the threshold value may be a number of account transactions, a number of views of the account balance, or another parameter.

The utility of the permissions grid may be illustrated by way of example. In a first example, the owner specifies an access permission authorizing a custodial entity to remove money or other holdings from an account. The owner also specifies a threshold value. In this example, the threshold value is a maximum amount that the custodial entity may debit from the account, for example, $1000. Using the computing device, the custodial entity initiates a transaction request to withdrawal money from the account. The custodial entity specifies an amount of money to withdrawal from the account by entering a value into the computing device (e.g., via the user interface of the computing device). The transaction request, including the type of request and the requested amount, is submitted by the computing device to the network server. A processor of the network server compares the requested amount to the threshold value to determine whether to accept or reject the request. The processor crawls through the permissions grid to determine whether the custodial entity has permission to perform a withdrawal. If the appropriate access permission (e.g., a withdrawal permission) is provided, the processor crawls through the permissions grid to identify the associated threshold value, in this case $1000. The processor compares this value with the requested amount. If the requested amount is equal to or below $1000, the processor approves the request (e.g., the processor submits the request to the authentication server to complete the request). If the requested amount is above $1000, the processor rejects the request. The processor may generate a notification to alert the custodial entity of the rejection. The processor may also generate a notification of the transaction request to an owner of the account or to another custodial entity so that they may take appropriate action.

In a second example, the custodial entity specifies an access permission authorizing the owner to remove money or other holdings from an account. The custodial entity specifies a threshold value. In this example, the threshold value is a maximum amount of money the owner can remove from the account, for example $500, without requiring the approval of the custodial entity. Using the computing device, the owner initiates a transaction request to withdrawal money from the account. The owner specifies an amount of money to withdrawal from the account by entering a value into the computing device (e.g., via the user interface of the computing device). The transaction request, including the type of request and the requested amount, is submitted by the computing device to the network server. A processor of the network server compares the requested amount to the threshold value to determine whether to accept the request or to generate a notification prompting the custodial entity to view and approve or deny the request. The processor crawls through the permissions grid to identify whether the owner has permission to perform the withdrawal. The processor crawls through the permissions grid to identify the associated threshold value, in this case $500. The processor compares this value with the requested amount. If the requested amount is above $500, the processor generates a notification and submits the notification to a computing device for the custodial entity. The notification prompts the custodial entity to view and approve or deny the request. The notification may include an alert, pop-up, e-mail communication, or another form of notification. The custodial entity may utilize the user interface of the computing device to approve or deny the request (e.g., by viewing transaction details displayed on the user interface and selecting an “approve” button or a “deny” button). Inputs specified by the custodial entity may be submitted to the network server. If the network server receives an indication of approval, the network server may submit the transaction request to the authentication server for further processing.

The scenarios provided in the foregoing examples are provided for illustrative purposes only. Various alternative implementations are possible without departing from the inventive concepts disclosed herein. In any of the above examples, the roles of the custodial entity and the owner may be reversed. Additionally, the roles may be performed by two independent custodial entities.

Returning to FIG. 9, the permissions change may be requested by specifying the desired change from the modifiable permissions grid (e.g., by interacting with selectable items on the modifiable permissions grid through the user interface, etc.). In operation 1008, the permissions change request is transmitted from the computing device to the network server, which processes the request and modifies the permissions grid accordingly. In some embodiments, the processor of the network server crawls through (e.g., steps iteratively through) the modifiable permissions grid. The processor may compare each permission with the previous permissions grid to determine whether any of the parameters have been changed. The processor updates the permissions to match with those in the modifiable permissions grid. In some embodiments, a permissions change may require approval by one or more designated entities so as to reduce the likelihood of an improper permissions change.

Returning to FIG. 9, the transactions portion 904 of the dashboard 900 provides the owner and/or the custodial entity with the ability to submit transaction requests from the computing device to the network server. The transaction request may include a withdrawal request in which a request is submitted to debit money or other holdings from the account (e.g., an inter-account transfer from the account, a billing transaction, a purchase of stock, etc.). The transaction request may also include a deposit request in which a request is submitted to credit money or other holdings to the account (e.g., an inter-account transfer into the account, a sale of a stock, etc.).

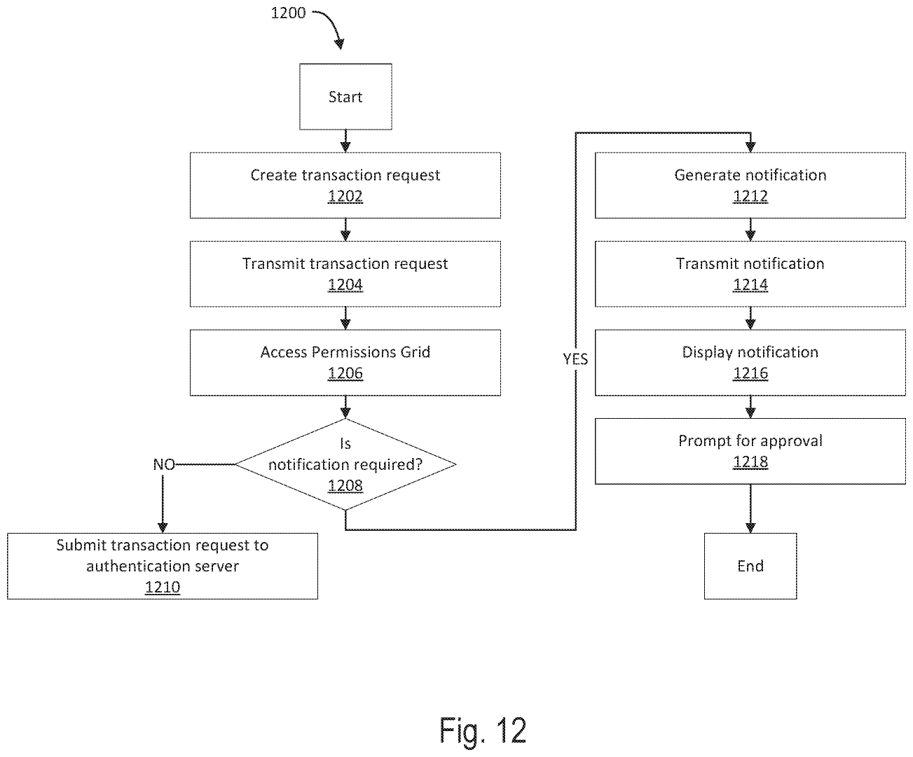

FIG. 12 is a method 1200 of preparing and processing a transaction request for a custodial account management system, according to an illustrative embodiment. In alternative embodiments, the method 1200 may include additional, fewer, and/or different steps. In step 1202, a transaction request is initiated by the owner or the custodial entity. The transaction request may be created from the transactions portion 904 of the dashboard 900 as shown in FIG. 9. The transaction request may specify a transaction type (e.g., inter-account transfer, stock purchase, etc.), an amount for the transaction, and notes or signatures that verify the authenticity of the transaction. In step 1204, the computing device transmits the transaction request to the network server. In step 1206, the network server accesses the permissions grid to determine notification requirements associated with the transaction request (e.g., whether an entity from the list of authorized entities needs to be notified of the transaction). Step 1206 may include steps or operations that are the same or similar to the method 800 described in detail with reference to FIG. 8. If it is determined that a notification is not required (e.g., step 1208), the network server may direct (e.g., route, transmit, etc.) the transaction request to the authentication server (e.g., step 120). Conversely, if it is determined that a notification is required (e.g., step 1208), the network server may be configured to generate a notification of the transaction request (e.g., step 1212) and transmit the notification to the computing device (e.g., step 1214) so that corrective actions can be taken by the owner or the custodial entity. In some implementations, the request may be initiated by the custodial entity and require approval from the owner. In other implementations, the roles of the owner and the custodial entity may be reversed. In yet other implementations, the request may be initiated by a custodial entity and require approval from another custodial entity.

In step 1216, the computing device displays or otherwise alerts the owner or the custodial entity of the notification. The notification may include an audible alert notifying the owner or the custodial entity of the transaction request. The notification may also include a text message with high level details about the transaction and/or a link to the transaction request. As shown in FIG. 12, the method 1200 may also include prompting the owner or the custodial entity to view and approve or deny the transaction request (e.g., step 1218). Among other benefits, the notifications serve as an additional security measure to reduce the likelihood of fraudulent account transactions.

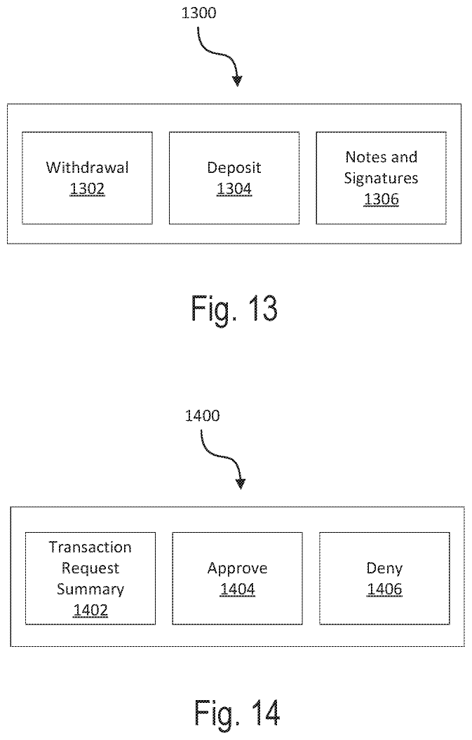

Referring to FIG. 9, the transactions portion 906 may include a transaction request window or link to a transaction request window. FIG. 13 is an illustration of a transaction request window 1300, according to an illustrative embodiment. The transaction request window 1300 provides the user with a convenient interface on the computing device from which parameters for the transaction may be specified. As shown in FIG. 13, the transaction request window 1300 includes a withdrawal button 1302, a deposit button 1304, and a notes and signatures button 1306. In alternative embodiments, the arrangement of the notification window 1400 and/or number of buttons 1402, 1404, 1406 may be different. Selecting the withdrawal button 1302 or the deposit button 1304 may present the user with a parameter window from which an amount of the transaction may be specified (e.g., an amount of money or other holdings to be transferred to or from the account) and a destination for account holdings. Selecting the notes and signatures button 1306 may cause a set of instructions to be presented to the user to enter any notes, signatures, or other information required for the transaction request. In an illustrative embodiment, the notes may include notes specifying a reason or justification for the transaction. The notes may be entered as text from the user interface of the computing device. Where a signature is required, the owner or custodial entity may be prompted to submit an e-signature or a photocopy of a wet signature, which may be stored electronically as part of the non-modifiable transaction history for the account. In some embodiments, the transaction request window 1300 may additionally include a submit button, which the owner or the custodial entity may select after completing the transaction request to trigger review and transmission.

Similar dialogue windows may be utilized to facilitate other account activities from the dashboard. FIG. 14 is an illustration of a notification window 1400, according to an illustrative embodiment. The notification window 1400 includes a transaction request summary button 1402, an approve button 1404, and a deny button 1406. In alternative embodiments, the arrangement of the notification window 1400 and/or the number of buttons 1402, 1404, 1406 may be different. In an illustrative embodiment, the transaction request summary button 1402 may link the owner or the custodial entity to information about the desired transaction amount, the type of transaction, or other transaction details. In alternative embodiments, the transaction summary may be displayed in the notification window directly. The approve button 1404 may be selected by an approver to signify that sufficient cause or justification has for the transaction has been provided. In some embodiments, selecting the deny button 1406 will prompt the owner or the custodial entity to enter comments explaining the deficiency in the transaction request.

Referring again to FIG. 9, the notifications portion 908 of the dashboard 900 may provide the owner or the custodial entity with access to past notifications or pending notifications that have not yet been reviewed. As with other portions of the dashboard 900, the notifications portion 908 may provide a brief summary of the notifications or provide the owner or the custodial entity with a link to the notifications.

The storage portion 910 of the dashboard 900 may contain protected or privileged data that may be directly or indirectly related to the accounts. For example, the storage portion 910 may include an electronically stored version of a trust or will generated by the owner of the account. Including an electronic version of the trust (e.g., photocopy, electronically administered, etc.) can, advantageously, provide secure access to the trust by only the owner or the custodial entities. The storage portion 910 may also include credentials for other services. For example, the storage portion 910 may include credentials for a mint account, a social media account, or another web service account to facilitate access to these services by the owner, on behalf of the owner by an authorized custodial entity.

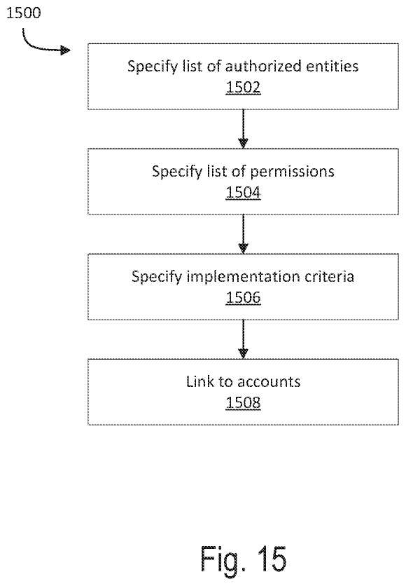

As shown in FIG. 9, the dashboard 900 may also include a setup portion 912 configured to curate initialization of the dashboard and the custodial account management system. The setup portion 912 may link an owner or a custodial entity to an interactive setup wizard that guides the owner or an authorized custodial entity through the initial setup. Alternatively, the setup portion 912 may be utilized by an authorized administrator or third party to setup the custodial account management system. FIG. 15 is a method 1500 of initializing (e.g., setting up, enabling, etc.) the custodial account management system by an account administrator, according to an illustrative embodiment.

In operation 1502, the account administrator is prompted to specify the list of authorized entities. The list may be a table of individual names including a temporary set of credentials for each custodial entity. In operation 1504, the account administrator is prompted to specify a list of permissions associated with each custodial entity. In operation 1506, the account administrator is prompted to specify implementation criteria for access by the custodial entities. The implementation criterial may determine a point at which access to the dashboard is provided to each custodial entity. The implementation criteria may be a date or a condition under which access is provided. In an illustrative embodiment, the parameters used to initialize the dashboard, and access to the dashboard by each custodial entity, may be tied (e.g., linked) to a trust or will of the owner of the account. For example, trustees from the trust or will may be utilized to specify a list of authorized entities. The list of permissions could include an approval permission that requires the owner to approve a custodial entity to act as a trustee and perform fiduciary transactions in that role. In operation 1508, the account administrator enters credentials and other information that may be required to link one or more accounts to the custodial management system.

In an illustrative embodiment, any of the operations described herein may be implemented at least in part as computer-readable instructions stored on a computer-readable memory. Upon execution of the computer-readable instructions by a processor, the computer-readable instructions can cause a computing device to perform the operations. For example, with reference to the method 500 of accessing account data as described with reference to FIG. 5, the instructions may include instructions to collect account data for an account from an authentication server, instructions to determine a portion of the account data that may be accessed by an owner of the account or a custodial entity based on a permissions grid, and instructions to transmit the portion of the account data in response to a request initiated by the owner or the custodial entity.

The instructions may include instructions to crawl through the permissions grid to identify permissions associated with the owner or the custodial entity, and instructions to selectively restrict the account data based on the permissions. The instructions may further include instructions to generate and transmit a modifiable permissions grid that provides functionality that allows the owner or the custodial entity to change a permissions associated with the entity or to submit a request to change the permission.

The embodiments described herein have been described with reference to drawings. The drawings illustrate certain details of specific embodiments that implement the systems, methods and programs described herein. However, describing the embodiments with drawings should not be construed as imposing on the disclosure any limitations present in the drawings.

It should be understood that no claim element herein is to be construed under the provisions of 35 U.S.C. § 112(f), unless the element is expressly recited using the phrase “means for.”

As used herein, a processor is implemented as a general-purpose processor, an application specific integrated circuit (ASIC), one or more field programmable gate arrays (FPGAs), a digital signal processor (DSP), a group of processing components, or other suitable electronic processing components. Additionally, in some arrangements, a “processor,” as used herein, is implemented as one or more processors. In certain embodiments, the one or more processors are structured to perform or otherwise execute certain operations independent of one or more co-processors. In other example embodiments, two or more processors are coupled via a bus to enable independent, parallel, pipelined, or multi-threaded instruction execution. In some arrangements, the one or more processors take the form of a single core processor, multi-core processor (e.g., a dual core processor, triple core processor, or quad core processor), microprocessor, etc. In some embodiments, the one or more processors are external to the apparatus, for example, the one or more processors are a remote processor (e.g., a cloud based processor). Alternatively, or additionally, the one or more processors are internal and/or local to the apparatus. Accordingly, an exemplary system for implementing the overall system or portions of the embodiments might include a general purpose computing computers in the form of computers, including a processing unit, a system memory, and a system bus that couples various system components including the system memory to the processing unit.

Additionally, as used herein, a memory includes one or more memory devices including non-transient volatile storage media, non-volatile storage media, non-transitory storage media (e.g., one or more volatile and/or non-volatile memories), etc. In some embodiments, the non-volatile media takes the form of ROM, flash memory (e.g., flash memory such as NAND, 3D NAND, NOR, or 3D NOR), EEPROM, MRAM, magnetic storage, hard discs, optical discs, etc. In some embodiments, the volatile storage media takes the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. In various arrangements, each respective memory device is operable to maintain or otherwise store information relating to the operations performed by one or more associated circuits, including processor instructions and related data (e.g., database components, object code components, or script components), in accordance with the example embodiments described herein.

It should be understood that a “transceiver” as used herein, includes any of a cellular transceiver (Code Division Multiple Access (CDMA), Global System for Mobile Communications (GSM), Long-Term Evolution (LTE), etc.), a wireless network transceiver (e.g., 802.11X, ZigBee, or Bluetooth), or a combination thereof (e.g., both a cellular transceiver and a Bluetooth transceiver). In some arrangements, a transceiver includes hardware and machine-readable media sufficient to support communication over multiple channels of data communication. Further, in some arrangements, the transceiver includes cryptography capabilities to establish a secure or relatively secure communication session between the device including the transceiver and other devices of the system. In this regard, data is encrypted and transmitted to prevent or substantially prevent the threat of hacking.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein show a specific order and composition of method steps, it is understood that in various embodiments the order of these steps differs from what is depicted. As an example, two or more steps are performed concurrently or with partial concurrence. Also, in various embodiments, some method steps that are performed as discrete steps are combined, steps being performed as a combined step are separated into discrete steps, the sequence of certain processes is reversed or otherwise varied, and/or the nature or number of discrete processes is altered or varied. Furthermore, the order or sequence of any element or apparatus is varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques, with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or as acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions can be made to the design, operating conditions and arrangement of the embodiments without departing from the scope of the present disclosure as expressed in the appended claims.

1. A method comprising:
collecting, by a network server, account data for a plurality of accounts, wherein each account of the plurality of accounts is one of a transactional account or an investment account, wherein the account data is received from a plurality of authentication servers corresponding to a plurality of financial institutions;
generating, by the network server, a first custodial dashboard that is accessible by a first computing device, the first custodial dashboard comprising a graphical user interface (GUI) presenting a plurality of display elements including a summary portion that includes account balances and non-modifiable transaction information for each of the plurality of accounts;
receiving, by the network server from the first computing device, via a transceiver of the network server, an access request for the account data from an owner of the accounts, wherein receiving the access request comprises receiving, by the network server through the first custodial dashboard, owner credentials that identify the owner of the plurality of accounts to the network server;
determining, by a processor of the network server in response to the access request, a portion of the account data that may be accessed by the owner based on a permissions grid stored in memory of the network server, wherein the permissions grid comprises a list of authorized entities, wherein the permissions grid further comprises a list of permissions associated with each entity from the list of authorized entities, and wherein determining the portion of the account data that may be accessed comprises:
selecting, by the processor of the network server, from the permissions grid, the list of permissions associated with the credentials to identify restricted data portions; and
selectively restricting the account data based on the list of permissions by iteratively removing the restricted data portions from the first custodial dashboard;
transmitting, by the network server, via the transceiver, the portion of the account data to the first computing device through the first custodial dashboard;
receiving, by the network server, a request from a requestor via the first computing device to modify permissions from the list of permissions associated with each entity of the list of authorized entities, wherein the permissions include an access permission and a threshold value, and wherein the threshold value includes at least one of an amount of a transaction or a number of transactions;
in response to the request to modify the permissions, crawling, by the network server, through the permissions grid to identify access permissions associated with the requestor;
generating, by the network server, an interactive modifiable permissions grid based on the identified access permissions;
transmitting, by the network server, the interactive modifiable permissions grid to the first computing device for presentation via a user interface;
receiving, by the network server via the user interface, an input requesting specific modification of at least one permission presented on the interactive modifiable permissions grid;
creating, by the network service, a list of modified permissions by updating the at least one permission in response to the received input requesting the specific modification of the at least one permission;
receiving, by the network server from the first computing device, via the transceiver, a first transaction request for an account of the plurality of accounts, wherein the first transaction request is initiated by the owner through the first custodial dashboard;
crawling, by the processor of the network server, through the list of permissions associated with the credentials to identify a threshold value associated with the first transaction request;
comparing, by the processor of the network server, an amount of the first transaction request with the threshold value; and
transmitting, by the network server to a second computing device, via the transceiver, a notification of the first transaction request by the first computing device based on a determination that the amount of the first transaction request exceeds the threshold value, wherein transmitting the notification of the first transaction request comprises:
generating, by the network server, a second custodial dashboard that is accessible by a custodial entity using the second computing device, the second custodial dashboard comprising a graphical user interface (GUI) presenting a second plurality of display elements including: a second summary portion that includes non-modifiable transaction information for the first transaction request, and prompts for the custodial entity to view and approve or deny the first transaction request; and
transmitting, by the network server to the second computing device, via the transceiver, a link that directs the custodial entity to the second custodial dashboard, wherein the second custodial dashboard comprises prompts for the custodial entity to view and approve or deny the second transaction request.

2. (canceled)

3. The method of claim 1, further comprising:
receiving, by the network server from the second computing device, an indication to approve the first transaction request; and
submitting, by the network server to at least one of the plurality of authentication servers, the first transaction request.

4. The method of claim 1, further comprising receiving, by the network server from the first computing device, a second transaction request initiated by the owner via the first custodial dashboard;
crawling, by the processor of the network server, through the list of permissions associated with the owner to identify a second threshold value indicative of a number of transaction requests;
comparing, by the processor of the network server, an actual number of transaction requests with the second threshold value; and
transmitting, by the network server to the second computing device, via the transceiver, a second notification of the second transaction request by the first computing device based on a determination that the actual number of transaction requests exceeds the second threshold value.

5. The method of claim 4, wherein the second notification includes a second link that directs the custodial entity to the second custodial dashboard.

6-8. (canceled)

9. The method of claim 1, wherein the list of permissions comprises at least one of a permission to view account balances, a permission to submit transaction requests, a permission to modify the list of authorized entities, and a permission to modify a threshold value.

10. The method of claim 9, wherein the threshold value is an amount of a transaction or a number of transactions.

11-17. (canceled)

18. A system comprising:
a network server comprising:
a transceiver configured to transmit and receive data from a plurality of authentication servers corresponding to a plurality of financial institutions and a plurality of user computing devices, wherein the plurality of authentication servers contain account data for a plurality of accounts, wherein each account of the plurality of accounts is one of a transactional account or an investment account;
a memory configured to store the account data retrieved from the plurality of authentication servers and a permissions grid, wherein the permissions grid comprises a list of authorized entities, wherein the list of authorized entities comprises at least one of an owner of the account or a custodial entity that is authorized by the owner to access at least one of the accounts, and wherein the permissions grid further comprises a list of permissions associated with each entity from the list of authorized entities; and
a processor operatively coupled to the memory and the transceiver, wherein the processor is configured to:
generate a first custodial dashboard that is accessible by a first computing device of the plurality of user computing devices, the first custodial dashboard comprising a graphical user interface (GUI) presenting a plurality of display elements including a summary portion that includes account balances and non-modifiable transaction information for each of the plurality of accounts;
receive, from the first computing device, via the transceiver, an access request for the account data from the owner, wherein receiving the access request comprises receiving, through the first custodial dashboard, owner credentials that identify the owner of the plurality of accounts;
determine a portion of the account data that may be accessed by the owner based on the permissions grid, wherein determining the portion of the account data that may be accessed comprises:
selecting from the permissions grid, the list of permissions associated with the credentials to identify restricted data portions from the first custodial dashboard; and
selectively restricting the account data based on the list of permissions by iteratively removing the restricted data portions from the first custodial dashboard;
transmit, via the transceiver, the portion of the account data to the first computing device through the first custodial dashboard;
receive a request from a requestor via the first computing device to modify permissions from the list of permissions associated with each entity of the list of authorized entities, wherein the permissions include an access permission and a threshold value, and wherein the threshold value includes at least one of an amount of a transaction or a number of transactions;
in response to the request to modify the permissions, crawl through the permissions grid to identify access permissions associated with the requestor;
generate an interactive modifiable permissions grid based on the identified access permissions;
transmit the interactive modifiable permissions grid to the first computing device for presentation via a user interface;
receive, via the user interface, an input requesting specific modification of at least one permission presented on the interactive modifiable permissions grid;
create a list of modified permissions by updating the at least one permission in response to the received input requesting the specific modification of the at least one permission;
receive, from the first computing device, via the transceiver, a first transaction request for an account of the plurality of accounts, wherein the first transaction request is initiated by the owner through the first custodial dashboard;
crawl through the list of permissions associated with the credentials to identify a threshold value associated with the first transaction request;
compare an amount of the first transaction request with the threshold value; and
transmit, to a second computing device of the plurality of user computing devices, via the transceiver, a notification of the first transaction request by the first computing device based on a determination that the amount of the first transaction request exceeds the threshold value, wherein transmitting the notification of the first transaction request comprises:
generating a second custodial dashboard that is accessible by a custodial entity using the second computing device, the second custodial dashboard comprising a graphical user interface (GUI) presenting a second plurality of display elements including: a second summary portion that includes non-modifiable transaction information for the first transaction request, and prompts for the custodial entity to view and approve or deny the first transaction request; and
transmitting, to the second computing device, via the transceiver, a link that directs the custodial entity to the second custodial dashboard, wherein the second custodial dashboard comprises prompts for the custodial entity to view and approve or deny the second transaction request.

19. (canceled)

20. The system of claim 18, wherein the processor is further configured to:
generate a modifiable permissions grid, wherein the modifiable permissions grid summarizes the list of permissions associated with an entity from the list of authorized entities, wherein the modifiable permissions grid provides functionality that allows at least one of the owner or the custodial entity to modify permissions associated with the entity, wherein the permissions include an access permission and a threshold value, and wherein the threshold value is an amount of a transaction or a number of transactions; and
populate at least one of the first custodial dashboard or the second custodial dashboard with the modifiable permissions grid.

21. The system of claim 18, wherein the list of permissions comprises at least one of a permission to view account balances, a permission to submit transaction requests, a permission to modify the list of authorized entities, and a permission to modify a threshold value.

22. The system of claim 18, further comprising:
the first computing device comprising:
a device transceiver configured to transmit and receive data from the network server;
a device memory configured to store an application, wherein the application is configured to provide access by the owner of the accounts to the first custodial dashboard containing the portion of the accounts;
a device user interface configured to display the application; and
a device processor operatively coupled to the device user interface, the device memory, and the device transceiver.

23. The system of claim 18, wherein at least one of the first custodial dashboard or the second custodial dashboard is configured to provide access to a modifiable permissions grid, wherein the modifiable permissions grid summarizes the list of permissions associated with an entity from the list of authorized entities, wherein the modifiable permissions grid provides functionality that allows at least one of the owner and the custodial entity to modify permissions associated the entity, wherein the permissions include an access permission and a threshold value, and wherein the threshold value is an amount of a transaction or a number of transactions.

24. The system of claim 18, wherein at least one of the first custodial dashboard or the second custodial dashboard comprises a printable summary, wherein the printable summary comprises the portion of the account data, and wherein the portion of the account data comprises a non-modifiable list of transaction operations.

25. The system of claim 22, wherein the first computing device is configured to collect, and transmit to the network server, via the device transceiver, the first transaction request, and wherein the first transaction request comprises a withdrawal request in which a request is submitted to debit holdings from at least one of the plurality of accounts.

26. The system of claim 25, wherein the threshold value is an amount of a transaction or a number of transactions, and wherein the application is configured to display the notification through the first custodial dashboard.
